(19) United States
(12) Patent Application Publication
(10) Pub. No.: US 2003/0075505 A1
(43) Pub. Date: Apr. 24, 2003

(54) Adsorption crossflow filitration method

(76) Inventors: Konrad Leonhard, Baldham (DE); Peter Janknecht, Unterschleissheim (DE); Karin Thudt, Munchen (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/265,188

(22) Filed: Oct. 7, 2002

(30) Foreign Application Priority Data
Oct. 5, 2001 (DE) 101 49 293.6

(51) Int. Cl. B01D 15/00; B01D 61/00

(52) U.S. Cl. 210/638; 210/806; 210/650; 210/660; 210/679; 210/644

(57) ABSTRACT

The invention relates to a method for separating out substances dissolved and/or undissolved in fluid media. The method is characterized by it being a suitable combination of a membrane filtration technique and an adsorption technique. This enhances the flow and purification capacity by a multiple factor in making a compact, lightweight system possible.

### DESCRIPTION

The invention relates to a method for separating out substances dissolved and/or undissolved in fluid media, it thus being intended for purification of such media, more particularly for the purification of water.

Wastewater and gray water treatment requires removal of substances dissolved and/or undissolved therein so that the water can either be reused or returned to natural water systems. A wealth of different filtering techniques or other techniques for removing more particularly dissolved substances is known from prior art, including membrane filtration techniques and adsorption techniques with a variety of adsorbents.

The requirements on the performance of the purification systems are particularly high when the important thing is low fresh water consumption simultaneously involving a water quality satisfying high hygiene standards. This relates more particularly to water systems providing only a limited availability of fresh water such as, for example, in aircraft, space stations and the like.

For the aforementioned applications membrane filtration techniques have the advantage of longer service intervals as compared to adsorption techniques. Particularly suitable in this respect as a membrane filtration technique is reverse osmosis. Reverse osmosis techniques necessitate, however, an operating pressure of at least 6 bar as generated by a pump. The membranes need to be flushed with the permeate every few minutes and daily with a purifier. A tank is needed as a reservoir for the purifier and a further pump for its delivery. A reverse osmosis system is relatively heavy and maintenance-intensive because of the pressure required and the low volume flow rate per membrane surface area.

This is why for applications in which low weight is a decisive requirement an adsorption technique and/or ion exchange technique employing activated carbon or synthetic resin media are employed for purifying the water. Recirculation showers based on this method are currently in use in some private and executive aircraft and employ fixed bed filters. These are so-called “cartridge filters” which are exhausted after being used 5 to 20 times and then need to be replaced new. Precisely defining the correct point in time for replacing the filter requires the quality of the treated water to be monitored or the quantity and degree of contamination of the water inflow to be precisely known.

Accordingly, techniques known hitherto in prior art fail to satisfy, or only in part, the requirements of an efficiently working purification system as need to be made especially on such units in which a predefined constant amount of water is in circulation. These requirements are high filtrate capacity coupled with a reduction in the membrane surface needed to a fraction of that normally required in thereby reducing the costs, size and weight of the system constituents.

### SUMMARY OF THE INVENTION

Accordingly, the present invention relates to a method for separating out substances dissolved and/or undissolved in fluid media wherein in a treatment system an adsorption technique is combined with crossflow filtration (CFF) and implemented either in sequence or simultaneously such that the adsorbent flows over the filter membrane(s) together with the fluid medium.

Combining the adsorption and filtration techniques in accordance with the invention achieves a surprisingly high filtrate capacity and a reduction in the membrane surface to a fraction of that normally required in thereby reducing the cost, size and weight of the system constituents. The high filtrate capacity is maintained as a result of a continuous self-cleaning effect which can be additional controlled via the adsorbent dosage in thus enabling longer service intervals to be achieved.

Preferred embodiments read from the sub-claims.

In accordance therewith it is of advantage procedurally to add a powdered adsorbent to the fluid requiring purification. The powdered adsorbent applied batchwise upstream of or into the filtration unit achieves, on the one hand, cleaning of the membrane so that additional chemical cleaning of the membrane is now either unnecessary or is at least minimized.

On the other, any substances dissolved or not are now bound by adsorption to the powdered adsorbent and separated out in the subsequent or simultaneous filtration step together therewith.

The purification capacity can be adapted to the type of water involved, depending on the choice and quantity of the adsorbent employed. To advantage, the adsorbent is selected from the group including activated carbons, alumina, silica gels, carbon black and/or zeoliths, preference being given to powdered activated carbons as the adsorbent. However, other products as employed in food processing may also be used, such as, for instance, bentonite as used in wine and fruit juice processing. For specifically eliminating ionic constituents of the water, for example salts and ionic tensides, ion exchange materials may be additionally employed. The adsorbents may be preferably added to the purification system directly or ready-mixed, singly or in combination.

Reliable separation of the contaminated powdered adsorbent is achievable by means of crossflow filtration with a membrane pore size of up to 200 nm. The flow capacity is significantly enhanced by the addition of the adsorbent as compared to simple filtration. If the water is to be simultaneously sterilized, reliable separation of constituents down to 10 nm is needed. This is why it is of advantage to select the pore size for the filter membrane of the crossflow system in the range 10 to 200 nm. Where high requirements on the hygiene of the treated water or fluid medium exist, a pore size of 10 nm is to be preferably selected.

Of the many crossflow filtration techniques known from prior art, preference is given to rotary filtration with a suitable filter material, for example, “KERAFOL” ceramic membrane filter disks. In rotary filtration the disk-shaped membrane filters rotate on a tubular shaft through which the permeate, i.e. the treated water, is drawn off. The filters are subjected by the their rotary to a flow parallel to the surface. In conventional crossflow filtration techniques this flow over the membrane filters needs to be produced by an additional pump which adds to the bulk of the system. In rotary filtration the high flow velocity over the membranes results in an exceptionally high permeate flux.

A test series comparing rotary filtration with 60 nm membranes to the method in accordance with the invention as a combination of rotary filtration and adsorption techniques (ACFF) produced the following results:

| | | Test Water | Rotary | |
|---|---|---|---|---|
| Data compared | Unit | Shower Waste | filtration | ACFF |
| Flow¹⁾ | l/min | — | 8.0 | 20.6 |
| TOC²⁾ | mg/l | 24 | 23.7 | 5.8 |
| COR³⁾ | mg/l | 94 | 72 | 10 |

¹⁾60 nm membrane, 4 bar
²⁾total organic carbon
³⁾chemical oxygen requirement

Flow, TOC as well as COR all proved to be significantly better as compared to the normal rotary filtration technique. The operating pressure of 2 to 4 bar as compared to that of reverse osmosis (6 to 30 bar) is also relatively low. The weight of the system is dictated primarily by the operating pressure and the filter surface area required. A 2.5 increase in the flow means a 2.5 reduction in the required membrane surface.

### BRIEF DESCRIPTION OF THE DRAWINGS

The invention will now be detailed with reference to the attached drawings in which:

FIG. 1 is a block diagram of a hot water treatment system (likewise subject matter of the present invention) as may be used, for example, in aircraft or space stations;

FIG. 2 is a flow diagram of the adsorption crossflow filtration method in accordance with the invention with upstream adsorption

FIG. 3 is a flow diagram of the same system but with simultaneous adsorption.

### DETAILLED DESCRIPTION

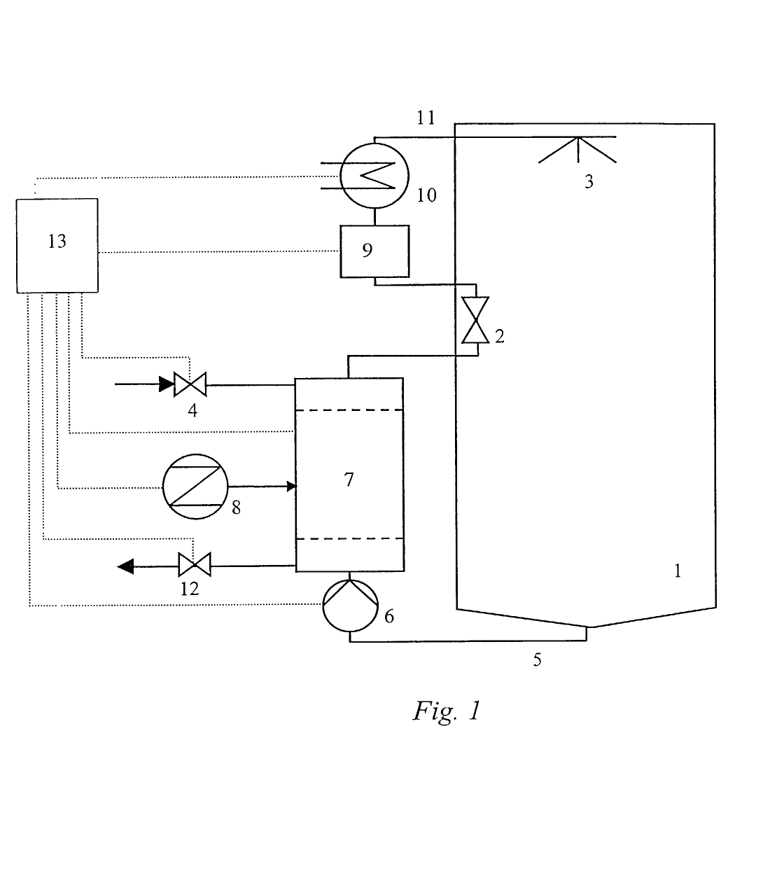

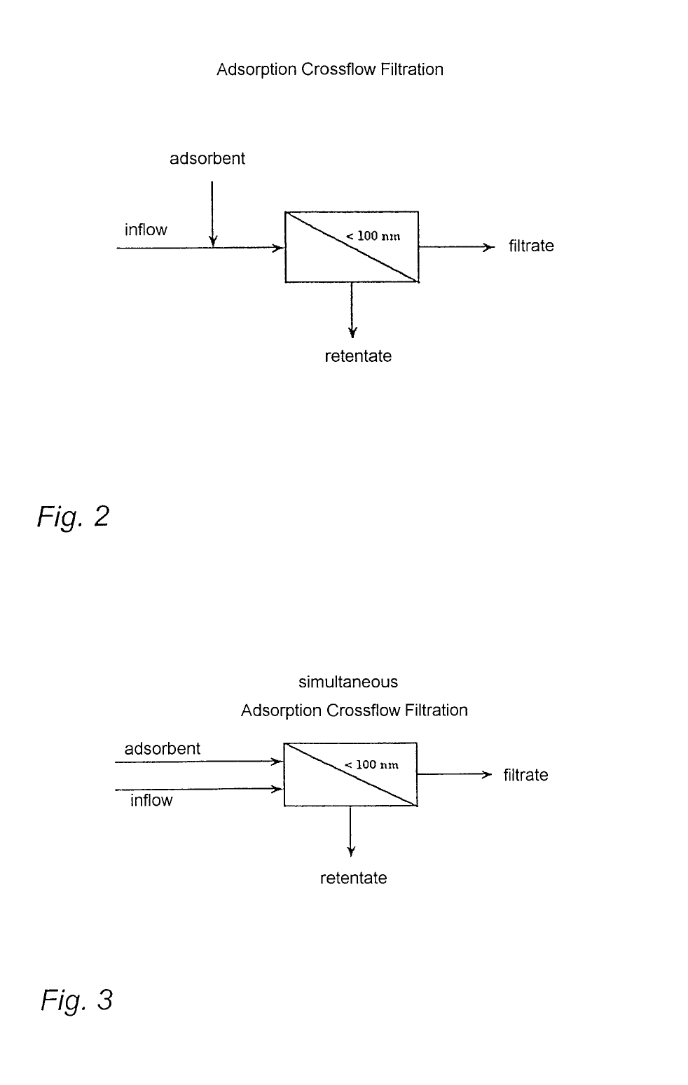

Referring now to FIG. 1 there is illustrated more particularly a shower booth 1 including a shower water fixture 2 and a shower head 3. On completion of a shower action the system is filled once via the valve 4. During the shower action, the water used therefor, also termed gray water, is collected in the shower pan, exhausted from the shower booth through the pipe 5 and pumped continuously by the pump 6 into the adsorption crossflow system 7. In this arrangement, the powdered adsorbent dosage is metered by a dispenser 8. The filtrate purged of substances dissolved and undissolved in the gray water, after passing the shower water fixture 2, is subsequently directed into a sterilizer 9 in which viruses and other germs are killed off, for example, by UV radiation or catalytic photo-oxidation. After passing through the temperature controller 10 the regenerated water is resupplied through the pipe 11 to the shower head 3. On completion of the shower action the system is totally discharged via the valve 12, this not only removing the wastewater but also the contaminated adsorbent having collected in the adsorption crossflow system. The controller 13 controls the inflow of fresh water and discharge of the system before and after the shower action respectively. During the shower action it controls the filling level, the water flow, the temperature of the water and the dosage of the adsorbent whilst maintaining continual operational control of the pump, the adsorption crossflow system, the sterilizer, the temperature controller as well as all aspects in purification.

With this system it is possible to restrict fresh water consumption to 20 to 30 liters of water per person which is continually treated during the shower action.

The person skilled in the art will readily appreciate that the adsorption crossflow filtration (ACFF) method in accordance with the invention in addition to finding application in gray water treatment in aircraft and space stations can be put to use in many other mobile and stationary fields of application in which saving water is decisive, such as, for instance, in mobile homes, in public transportation vehicles by road, rail and sea or in stand-alone buildings. In addition, the method can also be put to use in other areas requiring the separation of substances and media purification. This involves paper, food, textile, pharmaceuticals and biotechnologies as well as similar techniques as used in the field of environmental protection or in metal processing.

1. A method for separating out substances dissolved and/or undissolved in fluid media wherein in a treatment system an adsorption technique is combined with crossflow filtration and implemented either in sequence or simultaneously such that the adsorbent used flows over the filter membranes together with the fluid medium.

2. The method as set forth in claim 1, characterized in that a powdered adsorbent is employed.

3. The method as set forth in claim 1, characterized in that a powdered ion exchanger is employed.

4. The method as set forth in claim 1, characterized in that a powdered adsorbent and a powdered ion exchanger are simultaneously employed.

5. The method as set forth in claim 1 or 2, characterized in that the adsorbent is selected from the group including activated carbons, alumina, silica gels, carbon black and/or zeoliths.

6. The method as set forth in any of the claims 1 to 5, characterized in that the the crossflow filter membrane has a pore size in the range 5 to 200 nm.

7. The method as set forth in claim 6, characterized in that for sterilization the filter membrane has a pore size of max. 10 nm.

8. The method as set forth in any of the claims 1 to 7, characterized in that crossflow filter is implemented in accordance with the principle of rotary filtration.

9. The method as set forth in any of the claims 1 to 8, characterized in that it is implemented at a pressure in the range 2 to 4 bar.

10. The method as set forth in any of the claims 1 to 9, characterized in that the fluid medium is regenerated by it being recirculated through the filter unit.
